(19) United States
(12) Patent Application Publication
(10) Pub. No.: US 2014/0152534 A1
(43) Pub. Date: Jun. 5, 2014

(54) Selectively Steer Light from Display

(71) Applicant: Facebook, Inc,, Menlo Park, CA (US)

(72) Inventors: Gueorgui Djabarov, Sunnyvale, CA (US); Michael John McKenzie Toksvig, Palo Alto, CA (US); Benoit M. Schillings, Los Altos Hills, CA (US)

(73) Assignee: Facebook, Inc., Menlo Park, CA (US)

(21) Appl. No.: 13/692,417

(22) Filed: Dec. 3, 2012

(51) Int. Cl. G09G 3/34

(52) U.S. Cl. CPC G09G 3/3406; G09G 2320/0686
USPC 345/102

(57) ABSTRACT

In one embodiment, a computing device dynamically determines a current viewing direction with respect to a display of the computing device; the computing device also dynamically directs at least some light emitted by at least a portion of the display toward the current viewing direction.

### TECHNICAL FIELD

This disclosure generally relates to displays.

### BACKGROUND

A mobile computing device—such as a smartphone, tablet computer, or laptop computer—may include functionality for determining its location, direction, or orientation, such as a GPS receiver, compass, or gyroscope. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

In particular embodiments, a computing device may steer light emitted from a display of the computing device in a particular direction, instead of over a wide angular range. The particular direction may be dynamically determined. The particular direction may also be a fixed direction. Particular embodiments may reduce energy consumption by the display, as less light energy emitted from the display is needed to cover a smaller angular range in the particular direction for a given brightness.

### BRIEF DESCRIPTION OF THE DRAWINGS

FIGS. 1A and 1B illustrates an azimuth angle and an inclination angle of a display.

FIG. 1C illustrates an example viewing cone of a display.

FIG. 2 illustrates an example method for dynamically steering light emitted from a display.

FIG. 3 illustrates an example computer system.

### DESCRIPTION OF EXAMPLE EMBODIMENTS

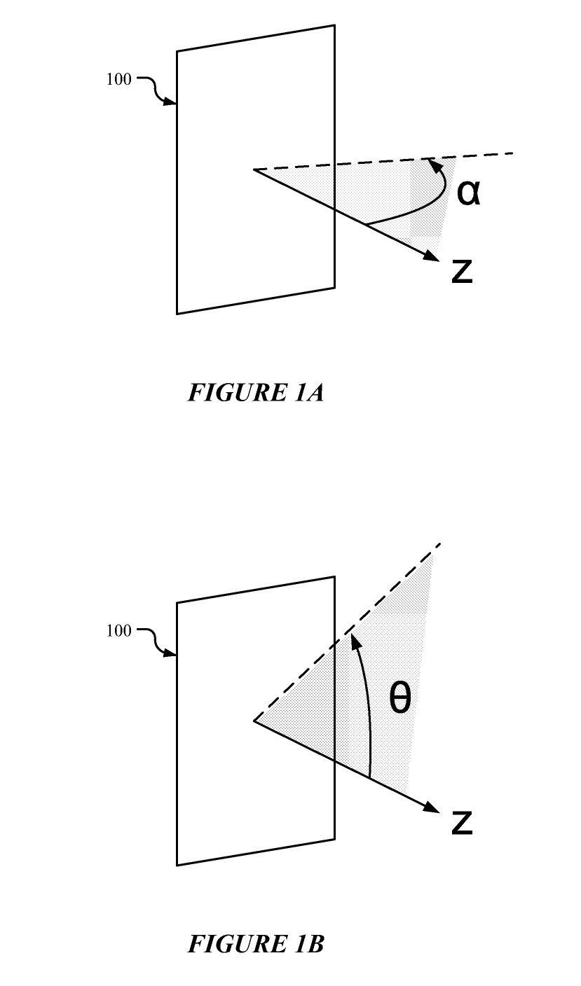

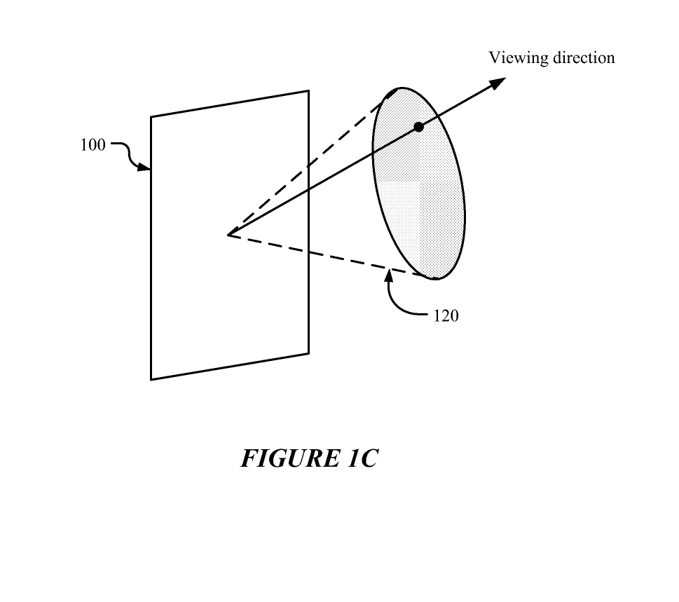

A display often uses a light source to provide a visible image on the display. For example, a backlight can illuminate a display from the side or back of the display panel. Displays such as liquid crystal displays (LCDs) often have internal built-in light sources for backlighting. Light from a light source of a display may spread over a wide angular range with respect to the display to provide a visible image to a user positioned at an angle within the angular range. FIG. 1A illustrates an azimuth angle of a display. In FIG. 1A, Z direction may be an axis pointing toward the front of a display 100 and perpendicular to the display 100. An azimuth angle α may be an angular measurement in degrees (°) away from the Z direction on a horizontal surface perpendicular to the display 100. FIG. 1B illustrates an inclination angle of the display 100 illustrated in FIG. 1A. In FIG. 1B, an inclination angle θ may be an angular measurement in degrees (°) away from the Z direction on a vertical surface perpendicular to the display 100. For example, light from a light source of a display may spread over an angular range between an azimuth angle of +/−70 degrees and between an inclination angle of +/−60 degrees to provide a visible image to a user positioned within the angular range.

Instead of providing light emitted from a display over a wide angular range, particular embodiments may dynamically steer light from a display toward a specific direction. For example, particular embodiments may dynamically steer light emitted from a display toward a specific direction of a person using the display. Particular embodiments may reduce energy consumption by the display, as less light energy emitted from the display is needed to cover a smaller angular range in the specific direction for a given brightness.

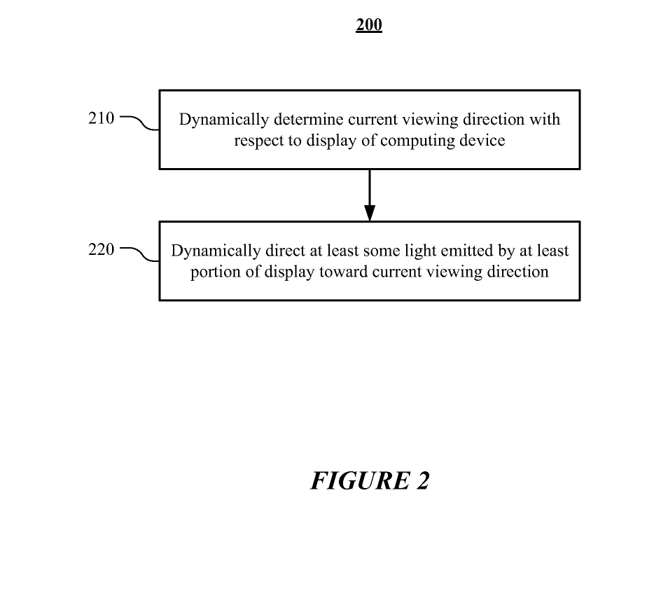

FIG. 2 illustrates an example method 200 for dynamically steering light emitted from a display. The method 200 may be implemented by a computing device with a display. The computing device may be a desktop computer, a laptop computer, a tablet computer, a smartphone, or any suitable computing device with a display. For example, the method 200 may be implemented by a software (or an operating system) running on the computing device. The method 200 may also be implemented with one or more device drivers associated with the display or other components of the computing device. The method 200 may begin at step 210. In particular embodiments, at step 210, a computing device may dynamically determine a current viewing direction with respect to a display of the computing device. The computing device may determine a current viewing direction as a direction (from the display) of a user currently viewing the display. The computing device may determine a direction of the user currently viewing the display based on a location of the eyes of the user. For example, an eye-tracking software running on the computing device may dynamically determine a location (relative to the computing device) of an user's eyes based on images (or video) captured by a front-facing camera of the computing device. The computing device may access the eye-tracking software (e.g., via an application programming interface or API) and dynamically determine a location of the user's eyes as the direction of the current viewing direction. Particular embodiments contemplate any suitable methods for determining a location of the eyes of a user facing the computing device. In particular embodiments, the computing device may determine an azimuth angle and an inclination angle (as illustrated in FIGS. 1A and 1B) of the current viewing direction. For example, the computing device may determine an azimuth angle of −10 degrees and an inclination angle of +30 degrees for the current viewing direction based on a location of the eyes of a user currently viewing the display. That is, the user's eyes are at an angle of −10 degrees in azimuth and +30 degrees in inclination with respect to the display.

In particular embodiments, at step 220, the computing device may dynamically direct at least some light emitted by at least a portion of the display toward the current viewing direction. For example, the computing device may direct light emitted by the display toward the current view direction of the eyes of the viewing user at an azimuth angle of −10 degrees and an inclination angle of +30 degrees as described above. Here, a viewing cone of a display may be a range of directions within which an image or video provided by the display may be seen without reduced visual performance. Light emitted from the display may be directed to fill the viewing cone to enable adequate brightness (and visual performance) within the viewing cone. FIG. 1C illustrates an example viewing cone 120 of the display 100 illustrated in FIG. 1A. As illustrated in FIG. 1C, the computing device may dynamically direct the light emitted by the display such that the viewing cone 120 of the display 100 is oriented toward the current viewing direction, or at least encompassing the current viewing direction. Furthermore, the viewing cone may have smaller angular range than a pre-set angular range of a display (i.e., pre-set viewing angles set by a manufacturer of the display), as the angular range of the viewing cone may only need to be wide enough to encompass the current viewing direction. For example, the display 100 illustrated in FIG. 1C may have pre-set viewing angles of +/−70 degrees in both azimuth and inclination directions of the display 100, while the viewing cone 120 may have a angular range of +/−20 degrees from an axis of the viewing cone 120. For a given brightness, steering light emitted from the display to fill the viewing cone thus may consume less light energy than emitting light to cover the entire pre-set viewing angles.

In particular embodiments, the computing device may dynamically direct the light emitted from the display by changing orientation of one or more components of the display. The computing device may dynamically direct the light emitted from the display without changing orientation of the computing device. The computing device may change orientation of components of the display by accessing one or more device drivers for the components. For example, the computing device may change orientation of one or more light sources of the display. The display may comprise directional or collimated light sources such as directional light emitting diodes (LEDs) or lasers (e.g., vertical-cavity surface-emitting lasers) that may be mounted on an array of pivoted support structures (e.g., an array of gimbals). The computing device may access one or more device drivers for the array of pivoted support structures to orientate the light sources toward the current viewing direction.

For another example, the display may comprise an array of micro-lenses that may direct light (e.g., backlight) passing through them. The computing device may access one or more device drivers for the array of micro-lenses to orientate light (passing through the micro-lenses) toward the current viewing direction. That is, the computing device may directing the light toward the current viewing direction by collimating the light.

For yet another example, the display may comprise an array of micro-mirrors that may direct light reflecting from them. The computing device may access one or more device drivers for the array of micro-mirrors to orientate light (reflecting from the micro-mirrors) toward the current viewing direction. That is, the computing device may directing the light toward the current viewing direction by collimating the light.

In one embodiment, the computing device may dynamically direct the light emitting from the display by changing orientation or curvature of the display. For example, the display may be mounted on a pivoted support structure. The computing device may access a device driver of the pivoted support structure to orientate the display toward the current viewing direction. For another example, the display may comprise a flexible screen (e.g., a flexible organic light-emitting diode screen) mounted a support structure configured to change a curvature of the display. The computing device may access a device driver of the support structure to change a curvature of the display such that light emitted from the display is collimated toward the current viewing direction.

In some embodiments, the computing device may determine a current viewing direction based on an orientation of the computing device. The computing device may determine an orientation (or a motion) of the computing device by accessing a device driver of an accelerometer or an gyroscope of the computing device. Particular embodiments contemplate any suitable method for determining an orientation of the computing device. For example, the computing device may determine that a user is viewing the display if the computing device determines that its orientation is in a vertical direction (or close to a vertical direction) such as the computing device being held in the user's hand. The computing device may determine the current viewing direction as a direction toward a location of the user's eyes as described above, and dynamically direct light emitted from the display toward the current viewing direction.

For another example, the computing device such as a smartphone may determine that it is idle if the computing device determines that it is facing upward (e.g., the computing device is placed on top of a desk) for a pre-determined period of time (e.g., two minutes). The computing device may determine a current viewing direction as a wide angular range (e.g., a pre-set viewing angle of the display), and provide light emitted from the display to fill the wide angular range. For example, the computing device may power off the display while the computing device is idle. The computing device may, in response to an incoming notification (e.g., an email notification, an Short Message Service or SMS message), turn on the display and cause the display to emit light to fill the wide angular range, such that a user can view the incoming notification (shown on the display) at a wide angle (e.g., away from the desk).

In one embodiment, the computing device may store in a local storage of the computing device one or more settings for viewing angles of the display. For example, the computing device may determine a preferred viewing direction of a user (e.g., at +10 degrees in inclination and −10 degrees in azimuth with respect to the display) based on a history of current viewing directions determined by the method 200 described above. The computing device may store the preferred viewing direction, and may cause the display to always to emit light toward the preferred direction. In addition, the stored viewing direction may be user-configurable. For example, a user may change the stored viewing direction to a pre-set angular range of the display (e.g., as set by a manufacture of the display). For example, a user may change the stored viewing direction to 0 degree in both inclination and azimuth directions, such that an image or video shown on the display can only be seen right in front of the display (e.g., for privacy reasons).

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

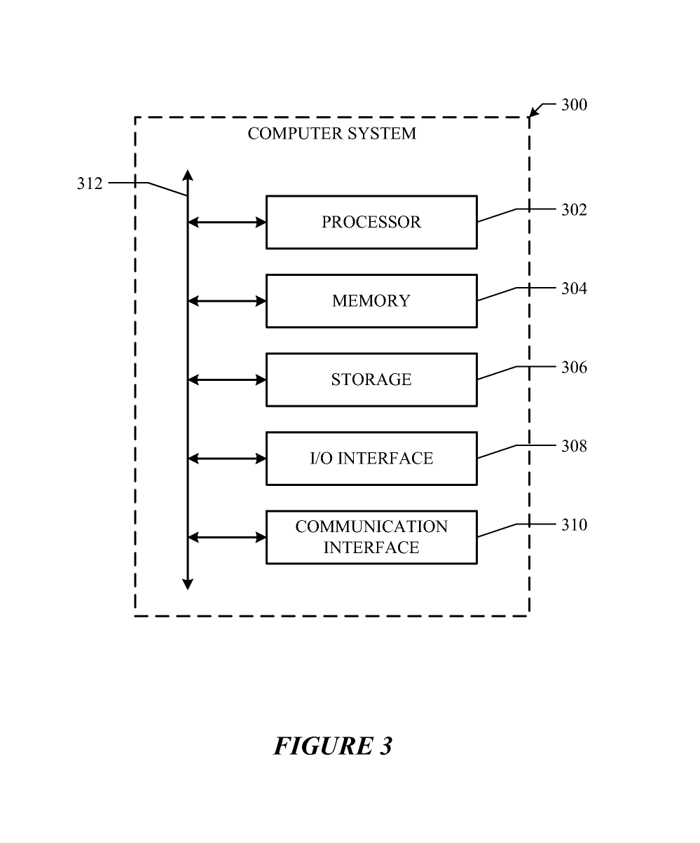

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by a computing device, dynamically determining a current viewing direction with respect to a display of the computing device; and
by the computing device, dynamically directing at least some light emitted by at least a portion of the display toward the current viewing direction.

2. The method of claim 1, wherein determining the current viewing direction comprises determining an inclination and an azimuth of the current viewing direction.

3. The method of claim 1, wherein directing the light comprises orienting a viewing cone of the display toward the current viewing direction.

4. The method of claim 1, wherein:
software on the computing device determines the current viewing direction; and
a device driver of the computing device directs the light toward the current viewing direction.

5. The method of claim 4, wherein the software is an operating system of the computing device.

6. The method of claim 1, wherein the light is directed without changing an orientation of the computing device.

7. The method of claim 1, wherein directing the light comprises changing orientation of one or more components of the display that:
are one or more sources of the light;
the light passes through; or
the light reflects off of.

8. The method of claim 1, wherein directing the light comprises collimating the light.

9. The method of claim 1, wherein the current viewing direction is determined at least in part based on a current orientation of the computing device.

10. The method of claim 1, wherein:
a user viewing the display comprises eyes; and
the current viewing direction is determined at least in part based on a location of the eyes of the user.

11. One or more computer-readable non-transitory storage media embodying software that is operable when executed by a computing device to:
dynamically determine a current viewing direction with respect to a display of the computing device; and
dynamically direct at least some light emitted by at least a portion of the display toward the current viewing direction.

12. The media of claim 11, wherein to determine the current viewing direction, the software if operable when executed by the computing device to determine an inclination and an azimuth of the current viewing direction.

13. The media of claim 11, wherein to direct the light, the software is operable when executed by the computing device to orient a viewing cone of the display toward the current viewing direction.

14. The media of claim 11, wherein:
the software determines the current viewing direction; and
a device driver of the computing device directs the light toward the current viewing direction.

15. The media of claim 14, wherein the software is an operating system of the computing device.

16. The media of claim 11, wherein the light is directed without changing an orientation of the computing device.

17. The media of claim 11, wherein to direct the light, the software is operable when executed by the computing device to change orientation of one or more components of the display that:
are one or more sources of the light;
the light passes through; or
the light reflects off of.

18. The media of claim 11, wherein to direct the light, the software is operable when executed by the computing device to collimate the light.

19. The media of claim 11, wherein the current viewing direction is determined at least in part based on a current orientation of the computing device.

20. The media of claim 11, wherein:
a user viewing the display comprises eyes; and
the current viewing direction is determined at least in part based on a location of the eyes of the user.
